(19) United States
(12) Patent Application Publication
(10) Pub. No.: US 2004/0208564 A1
(43) Pub. Date: Oct. 21, 2004

(54) Spectral dispersion compensation in optical code division multiple access (OCDMA) communication system

(76) Inventors: Rene P. Helbing, Palo Alto, CA (US); Kenneth R. Wildnauer, Santa Rosa, CA (US)

Correspondence Address: AGILENT TECHNOLOGIES, INC., P.O. Box 7599, Loveland, CO, 80537-0599, US

(21) Appl. No.: 10/087,152

(22) Filed: Mar. 1, 2002

(51) Int. Cl. H04B 10/00; H04B 10/12

(52) U.S. Cl. 398/77

(57) ABSTRACT

An apparatus and method for spectral dispersion compensation in an optical communication network are disclosed. In one embodiment, the invention comprises an optical medium having a signal distributed over a plurality of wavelengths, a demultiplexer adapted to receive the plurality of wavelengths and divide the plurality of wavelengths into individual wavelengths, and a plurality of dispersion compensation elements each adapted to receive a wavelength. The dispersion compensation elements alter the timing of each wavelength, where the plurality of dispersion compensation elements operates on all wavelengths simultaneously. The invention also comprises a multiplexer adapted to receive each individual wavelength and combine the individual wavelengths onto the optical medium.

### TECHNICAL FIELD

The present invention relates generally to optical fiber communication, and, more particularly, to dispersion compensation in an optical code division multiple access (OCDMA) communication system.

### BACKGROUND OF THE INVENTION

Optical communication systems have been in existence for some time and continue to increase in use due to the potentially large amount of bandwidth available for transporting signals. Optical communication systems provide high bandwidth and superior speed and are suitable for efficiently communicating large amounts of voice and data over both long and short distances. Optical communication systems are typically employed for both long (long haul) and short (short haul) distance communications applications, but are generally most efficient when used for long distance communications.

In a typical optical communication system, wavelength division multiplexing (WDM) allows the transmission of optical signals using multiple wavelengths on a single optical fiber. In such a communication system, a signal on one wavelength of an optical fiber contains all the information that is transmitted from a single source.

In conventional radio frequency (RF) wireless communication systems, a technique known as code division multiple access (CDMA) has been used to distribute a communication system over frequency and time to improve the capacity of these communication systems.

In an alternative proposed optical communication system, multiple wavelengths that may be transmitted on the same or different fibers would each contain a portion of the information that is transmitted, thus applying CDMA communication techniques to an optical communication system. In such a communication system, each optical wavelength would carry a portion of the communication signal transmitted. For example, each wavelength would contain one bit in a multiple bit code.

Unfortunately, because each optical signal travels at a different speed over the fiber, a condition known as spectral, or chromatic, dispersion occurs. Spectral dispersion results when the pulses that are transmitted on the optical fiber, and that represent the information transmitted broaden over the distance of the fiber span. When the pulses broaden, the possibility increases that the information carried in the pulse will be misinterpreted.

Spectral dispersion that occurs on a single channel optical wavelength is generally referred to as intra-wavelength spectral dispersion, while spectral dispersion that occurs between multiple wavelengths is generally referred to as inter-wavelength spectral dispersion.

The occurrence of inter-wavelength spectral dispersion prevents an optical communication system from employing CDMA coding techniques. Existing optical communication systems perform dispersion compensation only on single wavelengths with no consideration given to a signal that is distributed over a number of different wavelengths.

For a multi-wavelength OCMDA signal to be decoded properly, the bits communicated by the different wavelengths must be correlated. Accordingly, the wavelengths must arrive at a receiver in synchronization, or at least nearly so. Unfortunately, inter-wavelength spectral dispersion prevents signals on different wavelengths from arriving in synchronization, or nearly so, with each other.

Therefore, there is a need in to industry for spectral dispersion compensation in an optical communication system in which information contained in a signal is distributed over a number of different wavelengths.

### SUMMARY OF THE INVENTION

An embodiment of the invention is an apparatus for spectral dispersion compensation in an optical communication network. The invention comprises an optical medium having a signal distributed over a plurality of wavelengths, a demultiplexer adapted to receive the plurality of wavelengths and divide the plurality of wavelengths into individual wavelengths, where the individual wavelengths are relatively delayed to reduce inter-wavelength spectral dispersion. The invention also comprises a multiplexer adapted to receive each individual wavelength and combine the individual wavelengths onto the optical medium.

Another embodiment of the invention comprises a dispersion compensation element associated with each of the wavelengths. Each of the plurality of dispersion compensation elements is adapted to receive an individual wavelength. The dispersion compensation elements alter the timing of each wavelength, where the plurality of dispersion compensation elements operate on all wavelengths simultaneously and are configured to reduce inter-wavelength spectral dispersion.

The multiplexer and the demultiplexer may be a surface diffraction grating or an array waveguide (AWG) and the dispersion compensation elements may be Bragg gratings. The Bragg gratings may be, for example, fiber Bragg gratings or waveguide Bragg gratings. Further, to improve packaging efficiency, the multiplexer/demultiplexer and the Bragg grating may be fabricated on a single optical substrate. In the course of the invention, it was determined that in an OCDMA system, each wavelength must be correlated (i.e., arrive at the receiver at or near the same time) so that the code (communication signal) that is spread among all the wavelengths can be accurately decoded.

Aspects of the invention perform dispersion compensation simultaneously on a number of different wavelengths in an OCDMA communication system in which a communication signal is distributed over a plurality of wavelengths. Such dispersion compensation allows the multiple wavelengths to be used to transport optical signals in an OCDMA communication system. Further, the invention allows an optical communication system to employ OCDMA to efficiently use the bandwidth available on one or more optical fibers to maximize the efficiency of both long and short distance optical communication systems. Other advantages in addition to or in lieu of the foregoing are provided by certain embodiments of the invention, as is apparent from the description below with reference to the following drawings.

### BRIEF DESCRIPTION OF THE DRAWINGS

The invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an exemplar communication system in which the invention resides.

FIG. 2 is a schematic diagram illustrating a preferred embodiment of the dispersion compensation element of FIG. 1.

FIGS. 3A through 3C are graphical illustrations describing the operation of the invention.

FIG. 4 is a graphical illustration showing a multiplexer/demultiplexer and a plurality of Bragg gratings of FIG. 2 integrated in a single module.

### DETAILED DESCRIPTION OF THE PREFERRED EMBODIMENT

While described below using a single optical fiber, over which signals at multiple wavelengths are transmitted, the invention is also applicable to optical communication systems over which signals at different wavelengths are transmitted over multiple optical fibers.

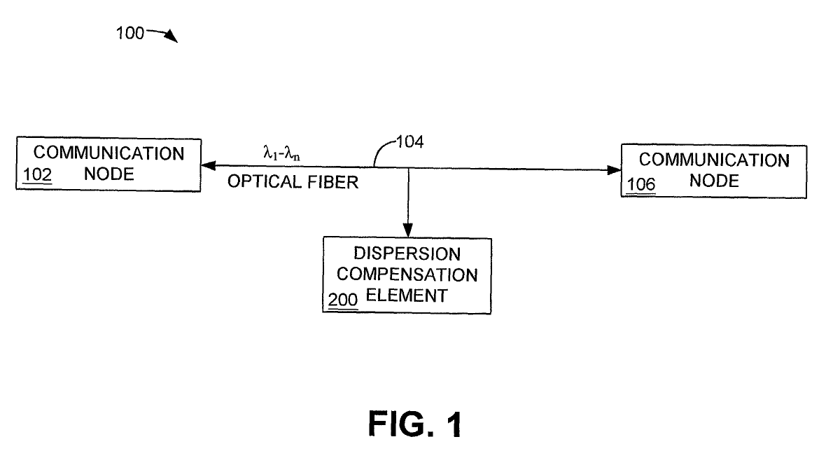

FIG. 1 is a block diagram illustrating an exemplar communication system 100 in which embodiments of the invention reside. The communication system 100 includes a first communication node 102 coupled to a second communication node 106 via an optical fiber 104. Each communication node 102 or 106 is illustratively an optical communication node and includes components that allow optical signals to be communicated between the nodes 102 and 106, as known to those having ordinary skill in the art. The communication system 100 also includes a dispersion compensation element 200 coupled to the optical fiber 104. Although connected using a single optical fiber 104, the communication node 102 can be coupled to the communication node 106 using a plurality of optical fibers. In accordance with an embodiment of the invention, the dispersion compensation element 200 compensates for spectral dispersion occurring between individual wavelengths communicated over the optical fiber 104. The dispersion compensation element 200 will simultaneously correct, or compensate, for spectral dispersion occurring between the different wavelengths carried over the optical fiber 104.

The communication system 100 is, in this preferred embodiment, an optical code division multiple access (OCDMA) communication system in which the optical fiber 104 carries an optical communication signal that is an encoded optical code division multiple access communication signal. The communication signal includes portions that are distributed over each wavelength (λ) that is carried on the fiber. Each wavelength in an OCDMA communication system carries a portion of the communication signal. Each portion of the communication signal represents a portion of the total signal that is being communicated.

For example, the portion of the signal on each wavelength represents one of a plurality of bits. The plurality of bits comprises what is referred to as the complete “code.” In order for useful information to be transmitted between communication node 102 and communication node 106, and because each optical wavelength carries a signal that represents one portion of the code, each signal portion on each wavelength should be received at the same time. Thought of another way, at any point in time, each of the signal portions on each of the wavelengths should be correlated with respect to time. The correlation of each wavelength allows the complete code carried by all of the wavelengths to be accurately decoded by a receiver in either the communication node 102 or the communication node 106.

It should be understood that the transmission that occurs between the communication node 102 and the communication node 106 can be bi-directional so that each communication node 102 and 106 includes both transmitting and receiving components. Further, while shown as coupled to a portion of the optical fiber 104 between communication node 102 and communication node 106, the dispersion compensation element 200 may reside within either or both of the communication nodes 102 and 106.

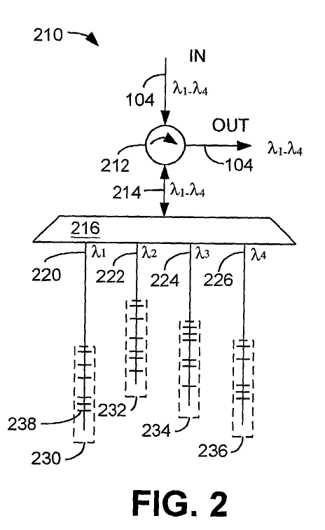

FIG. 2 is a schematic diagram illustrating a preferred embodiment 210 of the dispersion compensation element 200 of FIG. 1. The dispersion compensation system 210 resides anywhere between, and may be co-located with one of, the communication nodes 102 and 106 of FIG. 1. The dispersion compensation system 210 includes a non-reciprocal element, such as a circulator 212, that receives all of the optical wavelengths present on optical fiber 104. The circulator 12 is an optical element that passes incident light in one direction and directs reflected light in another direction. It should be mentioned that although shown using only four wavelengths λ₁ through λ₄ in FIG. 2, any number of wavelengths, up to the capacity of the optical fiber 104, can be carried on the optical fiber 104. Further, other optical mediums may be used to transport the communication signal.

The incident light supplied to the circulator 212 from the optical fiber 104 is directed through the circulator 212 and onto connection 214. The optical signal on connection 214 includes all of the wavelengths (in this example four (4)) present on optical fiber 104. Each of the wavelengths includes a portion of an encoded code-division multiple-access signal. In accordance with this embodiment of the invention, the four wavelengths on connection 214 are demultiplexed by multiplexer/demultiplexer (mux/demux) element 216. Mux/demux element 216 can be, for example but not limited to, an array waveguide grating (AWG) or a surface diffraction grating that is capable of spatially dividing an optical signal into wavelengths as known to those having ordinary skill in the art. The mux/demux 216 divides the optical signal on connection 214 into individual wavelengths for transmission to individual fibers or, preferably waveguides, so that dispersion compensation can be performed on each wavelength and between all the wavelengths.

For example, in the example shown in FIG. 2, the first wavelength λ₁ is supplied onto waveguide 220, the second wavelength 2 is supplied onto waveguide 222, the third wavelength 3 is supplied onto waveguide 224 and the fourth wavelength 4 is supplied onto waveguide 226. The four waveguides 220, 222, 224 and 226 lead to separate dispersion compensation elements 230, 232, 234 and 236, respectively. The dispersion compensation system 210 is designed to compensate for intra and inter-wavelength dispersion that may occur among the wavelengths λ₁, λ₂, λ₃ and λ₄. The inter-wavelength dispersion compensation can be performed by the waveguides 220, 222, 224 and 226 having different lengths with respect to each other, by the different dispersion compensation elements 230, 232, 234 and 236 having different delay characteristics, or by a combination of the two. Indeed, each of the waveguides 220, 222, 224 and 226 could be the same, or similar, length and differences in the delay characteristics of the dispersion compensation elements 230, 232, 234 and 236 can be used to perform the inter-wavelength dispersion compensation. In this manner, the individual wavelengths are delayed relative to each other to reduce inter-wavelength spectral dispersion.

Each of the waveguides 220, 222, 224 and 226 leads to a respective dispersion compensation element 230, 232, 234 and 236. In accordance with this embodiment of the invention, the dispersion compensation elements 230 through 236 are arranged in parallel so that they each simultaneously receive one of the wavelengths λ₁ through λ₄. Each dispersion compensation element can be, for example but not limited to, a fiber or waveguide based Bragg grating. Alternatively, other suitable optical elements that can alter the relative timing of the optical signals on the different wavelengths may be used. Further, intra-wavelength dispersion is compensated for each wavelength by the individual dispersion compensation element associated with a particular wavelength.

Preferably, the mux/demux and each dispersion compensation element is an integrated, waveguide based element that combines an array waveguide (AWG) (the mux/demux 216) and a waveguide Bragg grating (the dispersion compensation elements 230, 232, 234 and 236) on a single optical substrate.

A Bragg grating, an exemplar one of which will be described with reference to reference numeral 230, includes a plurality of periodic changes in refractive index, as indicated by a series of marks, an exemplar one of which is indicated using reference numeral 238. The periodic changes alter the refractive index, and therefore, the delay characteristics, of the dispersion compensation element 230. Such a dispersion compensation element 230 is sometimes referred to as a “chirped” grating. The periodic changes in refractive index for each of the dispersion compensation elements 230 through 236 are located in a different respective location, depending upon the wavelength of the optical signal that each dispersion compensation element is designed to reflect.

Each dispersion compensation element 230, 232, 234 and 236 receives a respective optical signal at a particular wavelength, and reflects that wavelength at a time determined by the periodic changes in refractive index 238 on each dispersion compensation element. For example, slower wavelength signals are returned earlier while faster wavelength signals are returned later. In this manner, the detrimental effect of spectral dispersion that occurs on each wavelength and between different wavelengths will be individually and simultaneously compensated for each wavelength so that each wavelength will arrive at its destination at, or close to, the same time.

As each optical signal portion corresponding to each wavelength λ₁ through λ₄ is reflected by a respective dispersion compensation element 230 through 236, the wavelengths are then multiplexed by the mux/demux element 216 and directed onto connection 214. The entire spectrum (λ₁ through λ₄) is then directed to the circulator 212, which routes the optical signal on connection 214 onto optical fiber 104. The optical signal on optical fiber 104 at the output of the circulator 212 is a signal in which the spectral dispersion of the wavelengths are compensated and are therefore correlated with respect to time.

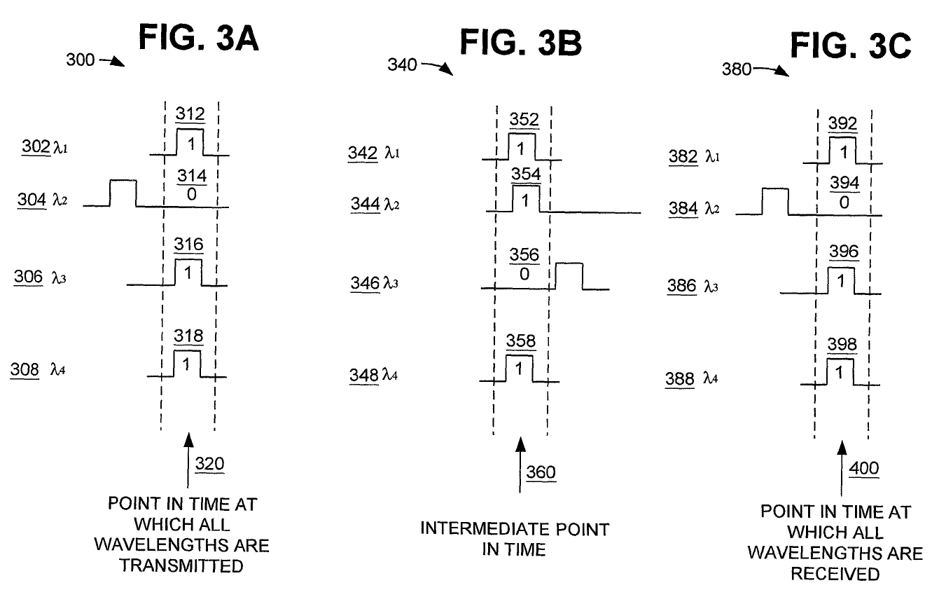

FIGS. 3A through 3C are graphical illustrations describing the operation of the invention. In FIG. 3A, the signal portion on each wavelength is shown as a digital pulse corresponding either to a logic 1 or a logic 0. For example, the first wavelength λ₁ 302 carries a pulse 312 that corresponds to a logic 1. The second wavelength λ₂ 304 is shown as the absence of a pulse, thus representing a logic 0 (314), the third wavelength λ₃ 306 carries a pulse 316 that corresponds to a logic 1, and a fourth wavelength λ₄ 308 carries a pulse 318 that corresponds to a logic 1. Importantly, in an OCDMA system, each of the wavelengths are correlated with respect to time, so that at any point in time (for example, time 320 at which the pulses 312, 316 and 318, and the logic 0 (314), are transmitted) all the wavelengths and corresponding pulses are properly aligned with respect to time. As shown in FIG. 3A, the four wavelengths represent a logical four (4) bit word having the information 1011.

FIG. 3B is a graphical illustration 340 illustrating the detrimental effect of spectral dispersion. As shown, the second wavelength λ₂ 344 now appears to represent a logic 1. This is so because spectral dispersion occurring on wavelength λ₂ 344 has caused the original pulse (wavelength λ₂ 304 representing a logic 0 (314) in FIG. 3A) to shift in time with respect to the other wavelengths so that at time 360 a pulse 354 appears to represent a logic 1. Similarly, the third wavelength λ₃ 346 at time 360 represents a logic 0, while at time 320 the pulse 316 represented a logic 1. The originally transmitted four-bit word 1011 at time 320 has been corrupted due to spectral dispersion to represent the four-bit word 1101 at time 360. By providing spectral dispersion compensation simultaneously, and concurrently, on each of the wavelengths, as shown in FIG. 2, the four wavelengths will be properly correlated with respect to time.

FIG. 3C is a graphical illustration showing the four wavelengths λ₁ through λ₄ of FIG. 3B after being compensated by the dispersion compensation element 200 of FIG. 1. As shown, each of the pulses 392, 396 and 398, and the logic 0 (394), at time 400 correspond to each originally transmitted pulse shown in FIG. 3A, and represent the originally transmitted four bit word 1011.

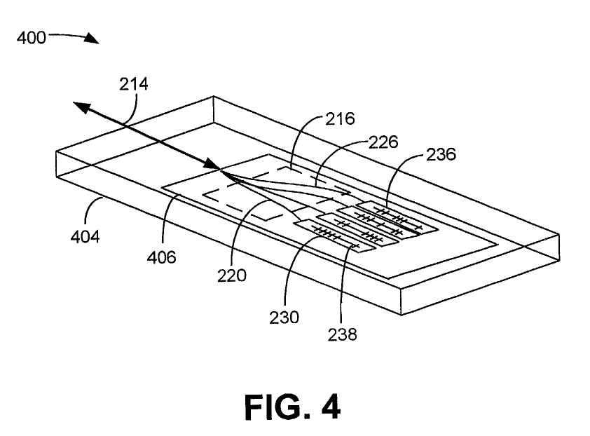

FIG. 4 is a graphical illustration showing a mux/demux 216 and a plurality of Bragg gratings 230, 232, 234 and 236 (of FIG. 2) integrated in a single module 400. The module 400 includes a ceramic module 404 over which a silica waveguide element 406 is constructed. The silica waveguide element 406 includes the mux/demux 216 and the Bragg gratings 230, 232, 234 and 236. In this example, the mux/demux 216 is preferably an array waveguide (AWG) and each of the Bragg gratings is preferably a waveguide Bragg grating. The silica waveguide element 406 receives all wavelengths of light over connection 214.

The silica waveguide element 406, and more specifically, the mux/demux 216 fabricated thereon, include the individual waveguides 220, 222, 224 and 226 that couple the light on connection 214 to respective dispersion compensation elements 230, 232, 234 and 236. Each dispersion compensation element 230, 232, 234 and 236 receives a respective optical signal at a particular wavelength and reflects that wavelength at a time determined by the periodic changes in refractive index 238 on each dispersion compensation element 230, 232, 234 and 236. For example, slower wavelength signals are returned earlier while faster wavelength signals are returned later.

In this manner, the detrimental effect of spectral dispersion that occurs on each wavelength will be individually and simultaneously compensated for each wavelength and between wavelengths so that each wavelength will arrive at its destination at, or close to, the same time. As each optical signal corresponding to each wavelength λ₁ through λ₄ is reflected by a respective dispersion compensation element 230 through 236, the wavelengths are then multiplexed by the mux/demux element 216 and directed onto connection 214. As shown in FIG. 4, the mux/demux 216 and the dispersion compensation elements 230, 232, 234 and 236 can be integrated onto the silica waveguide element 406, which can then be secured to the ceramic module 404.

It will be apparent to those skilled in the art that many modifications and variations may be made to the preferred embodiments of the present invention, as set forth above, without departing substantially from the principles of the present invention. For example, many optical communication systems that have been difficult to implement using OCDMA can benefit from the invention. All such modifications and variations are intended to be included herein within the scope of the present invention, as defined in the claims that follow.

What is claimed is:

1. An apparatus for spectral dispersion compensation in an optical communication network, comprising:
at least one optical medium having a signal distributed over a plurality of wavelengths, a portion of the signal on each wavelength;
a demultiplexer adapted to receive the plurality of wavelengths and divide the plurality of wavelengths into individual wavelengths, the individual wavelengths relatively delayed to reduce inter-wavelength spectral dispersion; and
a multiplexer adapted to receive each wavelength and combine the wavelengths onto the optical medium.

2. The apparatus of claim 1, further comprising a dispersion compensation element associated with each wavelength, the dispersion compensation element configured to reduce inter-wavelength spectral dispersion.

3. The apparatus of claim 2, wherein the dispersion compensation element is a Bragg grating.

4. The apparatus of claim 3, wherein the Bragg grating is a fiber Bragg grating.

5. The apparatus of claim 3, wherein the Bragg grating is a waveguide Bragg grating.

6. The apparatus of claim 1, wherein the multiplexer and the demultiplexer are a surface diffraction grating.

7. The apparatus of claim 1, wherein the multiplexer and the demultiplexer are an array waveguide (AWG).

8. The apparatus of claim 2, wherein the multiplexer and demultiplexer are an array waveguide and the dispersion compensation elements are waveguide Bragg gratings and the array waveguide and the waveguide Bragg gratings are combined on a single optical substrate.

9. The apparatus of claim 1, wherein the optical network is an optical code division multiple access (OCDMA) network and each wavelength comprises information that represents a portion of the signal.

10. The apparatus of claim 2, wherein the dispersion compensation element is located at an endpoint of the optical communication network.

11. The apparatus of claim 2, wherein the dispersion compensation element correlates the portion of the signal on each wavelength with respect to time.

12. The apparatus of claim 1, wherein the multiplexer and the demultiplexer are a single element.

13. A method for spectral dispersion compensation in an optical network, comprising:
supplying a signal distributed over a plurality of wavelengths to a demultiplexer;
dividing the plurality of wavelengths into individual wavelengths;
simultaneously altering the relative timing among the wavelengths using a dispersion compensation element associated with each wavelength to reduce inter-wavelength spectral dispersion; and
combining each wavelength onto an optical medium.

14. The method of claim 13, wherein the altering step is performed by a Bragg grating.

15. The method of claim 14, further comprising the steps of:
forming the demultiplexer as an array waveguide; and
forming the dispersion compensation elements as waveguide Bragg gratings.

16. The method of claim 15, farther comprising the step of forming the demultiplexer and the dispersion compensation elements on a single optical substrate.

17. The method of claim 13, wherein the optical network is an optical code division multiple access (OCDMA) network and each wavelength comprises information that represents a portion of the signal.

18. The method of claim 13, wherein the step of simultaneously altering the timing of each wavelength is performed at one end of the optical communication network.

19. The method of claim 13, wherein the step of simultaneously altering the timing of each wavelength correlates each signal portion with respect to time.

20. An apparatus for spectral dispersion compensation in an optical network, comprising:
means for supplying a signal distributed over a plurality of wavelengths to a demultiplexer;
means for dividing the plurality of wavelengths into individual wavelengths;
means for simultaneously altering the relative timing of the wavelengths to reduce inter-wavelength dispersion; and
means for combining each wavelength onto an optical medium.

21. The apparatus of claim 20, wherein the means for simultaneously altering the timing of each wavelength is performed by a dispersion compensation element associated with each wavelength.

22. The apparatus of claim 21, further comprising:
means for forming the demultiplexer as an array waveguide; and
means for forming the dispersion compensation elements as waveguide Bragg gratings.

23. The apparatus of claim 22, further comprising means for forming the demultiplexer and the dispersion compensation elements on a single optical substrate.

24. The apparatus of claim 20, wherein the optical network is an optical code division multiple access (OCDMA) network and each wavelength comprises information that represents a portion of the signal.

25. The apparatus of claim 20, wherein the means for simultaneously altering the relative timing of each wavelength operates at one end of the optical communication network.

26. The apparatus of claim 20, wherein the means for simultaneously altering the relative timing of each wavelength correlates each signal with respect to time.

27. A spectral dispersion compensator for an optical signal distributed over a plurality of wavelengths, the dispersion compensator comprising:
a demultiplexer for spatially dividing an incoming optical signal according to the wavelengths;
plural dispersion compensation elements for adjusting the relative timing of all of the wavelengths concurrently; and
a multiplexer for combining the wavelengths as adjusted into an outgoing optical signal.

28. The spectral dispersion compensator of claim 27, further comprising an optical coupler for coupling the incoming optical signal from a first optical fiber to the demultiplexer and for coupling the outgoing optical signal from the multiplexer into a second optical fiber.

29. The spectral dispersion compensator of claim 28, wherein the optical coupler is an optical circulator.

30. The spectral dispersion compensator of claim 27, wherein the optical signal is an optical code division multiple access signal.

31. A method for spectral dispersion compensation for an optical signal distributed over a plurality of wavelengths, the method comprising the steps of:
spatially dividing an incoming optical signal according to the wavelengths;
adjusting the relative timing of all of the wavelengths concurrently; and
combining the wavelengths as adjusted into an outgoing optical signal.

32. The method of claim 31, further comprising the steps of:
coupling the incoming optical signal from a first optical fiber to the demultiplexer; and
coupling the outgoing optical signal from the multiplexer into a second optical fiber.

33. The method of claim 31, wherein the optical signal is an optical code division multiple access signal.

34. The method of claim 31, further comprising correcting for spectral dispersion within each of the wavelengths.

35. An optical device comprising:
demultiplexer means for spatially separating by wavelength encoded components of an optical-code division multiple access signal;
dispersion-correction means for introducing relative delays among the encoded components to yield dispersion-corrected encoded components; and
multiplexer means for spatially combining the dispersion-corrected encoded components.

36. The optical device of claim 35, wherein the dispersion correction means corrects for dispersion within each of the encoded components.

37. The optical device of claim 36, wherein the dispersion-correction means includes Bragg gratings corresponding to respective ones of the encoded components.

38. The optical device of claim 37, further comprising a multiplexer serving as both the multiplexer means and the demultiplexer means.

39. The optical device of claim 38, further comprising a monolithic structure including the multiplexer and the Bragg gratings.
